(19) United States
(12) Patent Application Publication
(10) Pub. No.: US 2021/0179774 A1
(43) Pub. Date: Jun. 17, 2021

(54) POLYMERIC ANTI-AGGLOMERANT HYDRATE INHIBITOR

(71) Applicant: Baker Hughes Oilfield Operations LLC, Houston, TX (US)

(72) Inventors: Vaithilingam Panchalingam, Friendswood, TX (US); Gordon T. Rivers, Houston, TX (US); Jonathan Stewart-Ayala, Houston, TX (US); Heather McEachem, Webster, TX (US)

(73) Assignee: Baker Hughes Oilfield Operations LLC, Houston, TX (US)

(21) Appl. No.: 16/713,671

(22) Filed: Dec. 13, 2019

(51) Int. Cl. C08G 63/60; C09K 8/52; C09K 8/035; C10G 75/04; C10L 3/10

(52) U.S. Cl. CPC C08G 63/60; C09K 8/52; C09K 8/035; C10L 2230/08; C10L 3/107; C09K 2208/22; C10L 2200/0259; C10G 75/04

(57) ABSTRACT

A polymeric anti-agglomerant hydrate inhibitor useful for preventing the formation of hydrate agglomerates in a multi-phase oilfield fluid may be synthesized via a condensation reaction between a cyclic anhydride and a tertiary amine-diol in the presence of a condensation catalyst to form a polyester amine precursor and a reaction of the polyester amine polymer precursor with an organic acid.

### TECHNICAL FIELD

The present invention relates to a polymeric anti-agglomerant hydrate inhibitor useful to prevent the agglomeration of hydrates in multiphase oilfield fluids.

### BACKGROUND

Flow assurance is a major component to successful and oil and gas production and transport. Over the years, there has been much attention paid to the development of chemical inhibitors to prevent the formation of solid crystals at temperatures above the freezing point of water (i.e. hydrates) that can occur when water, oil, and gas is combined under pressure and to prevent blockages by these hydrates in the pipeline, which, if left unmanaged, can lead to costly problems.

In the past, formation of gas hydrates in subsea production facilities has been managed by keeping the fluids warm, removing water, or by injecting thermodynamic inhibitors. Thermodynamic inhibitors suppress the point at which hydrates form, much like an antifreeze for water-ice, allowing for hydrate protection under even the most severe formation conditions. The most common of these thermodynamic hydrate inhibitors are methanol and glycols, like monoethylene glycol.

One disadvantage to the use of a methanol inhibitor is that the greater the subcooling, i.e., more severe the hydrate problem, the more methanol is required. Capital and operating costs together with production feasibility for new facilities design are negatively impacted when large volumes of methanol are required.

To avoid the large operating and capital costs that could potentially result with the use of thermodynamic inhibitors, two low-dosage additives for the control of gas hydrates have been developed: kinetic hydrate inhibitors (“KHI”) and anti-agglomerant inhibitors (“AA”). KHIs delay the onset of hydrate formation while AAs allow small hydrate crystals to form but prevent or inhibit them from agglomerating into larger crystals capable of forming hydrate plugs. Both of these types of inhibitors have been able to achieve hydrate control through dosages that are orders of magnitude lower than the dosages of methanol typically required.

However, there are corrosivity concerns with a few of the AA inhibitors that have been developed, which has restricted their utility. For instance, AA inhibitors based on quaternary ammonium chloride have been shown to be corrosive to the metal surfaces exposed to this chemical during storage, transportation, and injection. In many cases, expensive solvents, such as isopropyl alcohol and aromatic solvents, have to be included in the corrosion inhibitor package to try to offset the corrosion that occurs when quaternary ammonium chloride AA inhibitors are used. Yet, even with these expensive solutions, corrosion protection is often not adequate. In addition, some AA inhibitors employed have been shown to be toxic and have been banned from use in places like the North Sea where toxicity is a concern.

Therefore, it would be desirable to develop effective AA inhibitors that are less costly, less corrosive, and not toxic.

### SUMMARY

There is provided, in one form, a method of synthesizing a polymeric anti-agglomerant hydrate inhibitor by: (1) forming a polyester amine polymeric precursor through a condensation reaction between cyclic anhydride and a tertiary amine-diol in the presence of a condensation catalyst; and (2) reacting the polyester amine polymer precursor with a carboxylic acid to create a polyester amine salt.

There is also provided, in another form, a method involving treating a multi-phase fluid with an effective amount of a polyester amine salt anti-agglomerant inhibitor, such as, as one non-limiting example, the polyester amine salt produced by the reactions set forth above, to prevent the agglomeration of hydrates in the multiphase fluid, wherein the amount of the polyester amine salt anti-agglomerant hydrate inhibitor is applied in a low dose and the multi-phase fluid comprises an aqueous phase, a liquid hydrocarbon phase, and/or natural gas, such as crude oil, production fluid, wet natural gas, drilling fluid, drill-in fluid, completion fluid, and mixtures thereof.

### DETAILED DESCRIPTION

It has been discovered that a polymeric anti-agglomerant hydrate inhibitor, synthesized by a condensation reaction between a cyclic anhydride and a tertiary amine in the presence of a condensation catalyst to produce a polyester amine precursor and a subsequent reaction of the polyester amine precursor with an organic acid or a quaternizing reaction with an alkylating agent, may be effective to inhibit (i.e. prevent or suppress) the agglomeration of hydrates in a multi-phase oilfield fluid. This polymeric anti-agglomerant hydrate inhibitor may be found to be biodegradable and less corrosive than conventional anti-agglomerant hydrate inhibitors currently sold and used.

In one non-restrictive embodiment, the polymeric anti-agglomerant hydrate inhibitor is made by first forming a polyester amine precursor through a condensation reaction between a cyclic anhydride and a tertiary amine-diol in the presence of a condensation catalyst, in which alkyl or alkenyl substituted anhydride is first stirred together with the condensation catalyst, such as, without limitation, methanesulfonic acid, p-toluenesulfonic acid, dodecylbenzenesulfonic acid, sulfuric acid, phosphoric acid, and/or phosphorous acid, and then the tertiary amine is slowly added. Once the tertiary amine is added, the combined contents are heated to a temperature ranging from about 50° C. to 250° C. in stages. The ratio of the anhydride used to tertiary amine-diol used may range from about 2:1 independently to about 1:2 independently, or from about 1.1:1 independently to about 1:1.1 independently. As used herein with respect to a range, “independently” means that any threshold given may be used together with any other threshold given to provide a suitable alternative range. Through the combination of the anhydride, the tertiary amine-diol, and the catalyst, and the heat applied, water is continually released to form a polyester amine molecule.

The cyclic anhydride that may be used to form the polyester amine precursor include, but are not limited to, an alkyl-substituted or alkenyl-substituted anhydrides in which the alkyl or alkenyl group has 1 to 20 carbon atoms. A non-limiting examples of an alkyl-substituted or alkenyl-substituted anhydride useful for forming the precursor is cis and/or trans isomers of linear or branched dodecenyl succinic anhydride, octenyl succinic anhydride, tetradecenyl succinic anhydride, and octadecenyl succinic anhydride. Other examples of anhydride reagents are, without limitation, maleic anhydride and succinic anhydride. In another non-limiting embodiment, the anhydride may be fused to a second cyclic ring, such as phthalic anhydride and hexahydrophthalic anhydride. These anhydride reagents may be included in the reaction individually or as a mixture. Alternatively, the precursor may be formed using, instead of an anhydride, a corresponding diacid. The diacids that may be used include, but are not limited to, alpha-omega diacids containing 2 to 20 carbon atoms. The alpha-omega diacids may be hydroxy substituted such as malic and tartaric acids.

Tertiary amine-diols suitable for the precursor formation reaction are, without limitation, alkyldiethanolamine, wherein the alkyl group contains 1 to 10 carbon atoms and is linear, branched, or cyclic. Another tertiary amine-diol that may be used in this precursor formation reaction is n-butyldiethanolamine. These tertiary amine-diols may be included in the reaction individually or as a mixture.

In the same non-limiting embodiment, the polyester amine precursor formed by the condensation reaction between the cyclic anhydride and a tertiary amine-diol is then reacted with an acid in a solvent to form a polyester amine salt that can then be used to treat oilfield fluids to inhibit the agglomeration of hydrates. The ratio of the amount of acid to the amount of polyester amine precursor ranges from about 0.001 independently to about 1000 independently, or from about 0.10 independently to about 10 independently, or from about 0.5 independently to about 1.5 independently.

The acids that may be reacted with the polyester amine precursor include, as a non-limiting example, organic acids, such as carboxylic acids having at least one carboxylic acid group and 1 to 20 carbon atoms, like acetic acid, acrylic acid, and citric acid. Other possible organic acids include, without limitation, sulfonic acids having 1 to 20 carbon atoms, such as methanesulfonic acid and dodecylbenzensulfonic acid, and anionic phosphate esters containing 1 or 2 alkyl groups, in which the alkyl group may contain 1 to 20 carbon atoms. An example of an anionic phosphate ester falling within these parameters is diethyl hydrogen phosphate. These acids may be included in the reaction individually or as a mixture.

In a non-limiting embodiment, the polyester amine salt synthesized from the reaction between the precursor and the acid is formulated in a solvent. Suitable solvents include, but are not limited to, alcohols having 1 to 10 carbon atoms such as methanol, isopropanol and butanol, glycols and oligomers containing at least 2 carbon atoms such as propylene glycol and diethylene glycol, glycol ethers such as ethylene glycol monobutyl ether, ketones containing 3 to 12 carbon atoms such as methyl isobutyl ketone, amides containing 3 to 6 carbon atoms such as dimethylformamide, esters containing 2 to 20 carbon atoms such as ethyl acetate, aromatic hydrocarbons containing 6 to 12 carbon atoms such as xylene, tolulene, and aromatic naphtha, phenols containing 6 to 12 carbon atoms such as cresol, and mixture thereof.

In an alternative embodiment, the polyester amine precursor formed by the condensation reaction between the cyclic anhydride and the tertiary amine-diol may then be quaternized with an alkylating agent to form another type of polymeric anti-agglomerant hydrate inhibitor that may be used in a multi-phase oilfield fluid to inhibit (i.e. prevent or suppress) the agglomeration of hydrates. In this embodiment, the tertiary nitrogen may be quarternized with an alkylating agent delivering 1 to 6 carbon atoms. The alkylating agents include, but are not limited to, alkyl halides, where the halide is chloride, bromide or iodide, such as methyl chloride and butyl bromide. Other alkylating agents may be dialkyl sulfates, like diethyl sulfate, dialkyl carbonates, like dimethyl carbonate, and alkyl salicylates, like methyl salicylate.

The fluid to be treated with a polyester amine salt synthesized via the method described herein may be a multi-phase oilfield fluid comprising an aqueous phase, a liquid hydrocarbon phase, and/or natural gas. The multi-phase oilfield fluid may exist at a temperature and pressure in which hydrates may form. In one non-restrictive embodiment, the multi-phase fluid is at a temperature ranging from about −10° C. to about 10° C. and at a pressure above 1000 psi. The aqueous phase of the fluid may be comprised of water or brine making up about 0.1 vol. % to about 80 vol. %, based on the total volume of liquid in the fluid. The aqueous phase may have a salinity of about 1 wt. % to about 24 wt. %. Such fluids may include, but are not necessarily limited to, crude oil, production fluid, wet natural gas, drilling fluid, drill-in fluid, completion fluid, and mixtures thereof. In one non-limiting embodiment, the synthesized polyester amine salt anti-agglomerant precursor may be introduced to the introduced to the liquid hydrocarbon phase to inhibit agglomeration of any hydrates in the fluid.

For purposes is this disclosure, the term “inhibit” means to prevent or suppress. While complete inhibition of the agglomeration of hydrates is desired, it should be appreciated that complete inhibition is not necessary for the methods and polymeric AA hydrate inhibitors discussed herein to be considered effective. Success is obtained if more hydrates in the fluid are prevented from agglomerating using an effective amount of the polymeric AA hydrate inhibitor of the present disclosure than in the absence of an effective amount of it. In a non-limiting embodiment, the effective amount of the polymeric AA hydrate inhibitor of the present disclosure that may be introduced or applied to the fluid for purposes of suppressing hydrate agglomeration in the fluid, ranges from about 0.1 vol. % independently to about 6.0 vol. % independently, or from about 0.5 vol. % independently to about 3.0 vol. % independently, based on the total volume of the aqueous phase of the fluid. It will be appreciated that these amounts would be considered to be “low doses” or “low dosages” to a person of ordinary skill in the art.

The invention will be illustrated further with reference to the following Examples, which are not intended to limit the invention, but instead illuminate it further.

### Examples

Several samples of polyester amine salt AA inhibitors of the kinds described in the present disclosure were synthesized using the steps and equipment described below:

In a first step, 62.3 g (0.23 mol) dodecenyl succinic anhydride (“DDSA) and 0.5 g p-toluenesulfonic acid (catalyst) was added to a 250 ml round bottom flask equipped with overhead stirrer, thermocouple, nitrogen inlet tube, Dean Stark condenser, reflux condenser, and nitrogen bubbler. After stirring this solution at 50° C., 37.7 g (0.23 mol) N-butyldiethanolamine (“NBDEA”) was slowly added and the reacted temperature rose to 90° C. The contents were heated to 170° C. in stages. Water of reaction was azeotropically removed using toluene to form a first sample of polyester amine precursor. A second sample of polyester amine precursor was formed using the same procedure but with 62.3 g (0.23 mol) DDSA and 41.5 g (0.25 mol) NBDEA.

The resulting polyester amine precursor samples were then reacted with citric acid and acrylic acid separately in methanol as a solvent to form the following samples of polyester amine salt AA inhibitors:
Example 1a: The resulting polyester amine (40.3 g; 0.1 mol) was salted with citric acid (9.7 g; (0.05 mol) in methanol (50.0 g) to obtain a 50% active product.
Example 1b: The resulting polyester amine (42.5 g; 0.1 mol) was salted with acrylic acid (7.5 g; 0.1 mol) in methanol to obtain a 50% active product.
Example 2a: The resulting polyester amine (39.6 g; 0.1 mol) was salted with citric acid (10.4 g; 0.05 mol) in methanol to obtain a 50% active product.
Example 2b: The resulting polyester amine (42.5 g; 0.1 mol) was salted with acrylic acid (7.5 g; 0.11 mol) in methanol to obtain a 50% active product.

The polyester amine salt AA samples listed above and samples of conventional AAs (Inhibitor A and Inhibitor B) were applied to 3% NaCl brine/Gulf of Mexico oil 1 at 30% water-cut and the performance of each AA was evaluated using a rocking cell unit. In this evaluation, the tester was composed of 10 sapphire cells for visual observations and a stainless steel ball and rated for pressure up to 5000 psi. The cells were charged with 3 ml sodium chloride brine and 7 ml black oil. The fluids in the cells were then charged with 0.5-1.0% (vol./vol.) doses of each polyester amine salt sample, based on the amount of brine. The cells were attached to the test unit and pressurized to 2800 psi with Green Canyon gas (composition shown in Table 1) at 75° F. The contents were equilibrated for 30 minutes at 75° F. and cooled to 40° F. with rocking. The cells were rocked for 24 hours at 40° F. and then shut-in for 6 hours with no rocking in a horizontal position. After the 6 hours shut-in, it was rocked again for 2 hours to evaluate the ball movement. A pass is indicated by free movement of the ball during the initial rockling and after the shut-in. The test results are summarized in Table 2.

TABLE 1
Typical Green Canyon Gas Composition
Used for AA Performance Testing

| Components | Mole % |
|---|---|
| Nitrogen | 0.4 |
| Methane | 87.2 |
| Ethane | 7.6 |
| Propane | 3.1 |
| Isobutane | 0.5 |
| n-Butane | 0.8 |
| Isopentane | 0.2 |
| n-Pentane | 0.2 |

TABLE 2
Rocking Cell Performance Test Data for
Example AAs and Conventional AAs

| | Dose Rate (Vol/Vol; | |
|---|---|---|
| Chemicals | Based on Brine) | Pass/Fail |
| Blank | 0 | Fail at 54° F. |
| Inhibitor A | 0.5 | Pass |
| Inhibitor A | 1.0 | Pass |
| Inhibitor B | 0.5 | Fail |
| Inhibitor B | 1.0 | Fail |
| AA Example 1a | 0.5 | Pass |
| AA Example 1a | 1.0 | Pass |
| AA Example 1b | 0.5 | Pass |
| AA Example 1b | 1.0 | Pass |
| AA Example 2a | 0.5 | Pass |
| AA Example 2a | 1.0 | Pass |
| AA Example 2b | 0.5 | Pass |
| AA Example 2b | 1.0 | Pass |

Table 2 shows that all of the polyester amine salt AA samples, when applied to the two-phase fluid in low dosages, passed the rocking cell unit test, which indicates they were effective in inhibiting the agglomeration of hydrates.

The performance of the polyester amine salt AA samples and samples of conventional AAs (Inhibitor A and Inhibitor B) were then evaluated using an autoclave testing unit. In this test, performance was assessed using a 750 ml size autoclave containing 225 ml 3.4 Total Dissolved Solids (“TDS”) brine as set forth in Table 3 and 150 ml Gulf of Mexico blank oil (60% water-cut). The autoclave unit has a variable speed stirrer motor and is rated for 20,000 psi. Hydrate agglomeration/blockage was monitored by measuring motor current. The test protocol, which includes temperature, pressure, cooling rate, stirrer speed, is shown in Table 4. A failure is indicated by motor current exceeding 3.75 A. A pass is indicated by stable motor current below 3.75 A throughout the test protocol. The results of the autoclave test are summarized in Table 5.

TABLE 3
Brine Composition for Autoclave Testing

| Components | Concentration (mg/L) |
|---|---|
| Chloride | 20,965 |
| Sodium | 12,900 |
| Calcium | 441 |
| Magnesium | 73 |
| Potassium | 70 |
| Strontium | 19 |
| Barium | 50 |
| Total Dissolved Solids (TDS) | 34,468 |

TABLE 4
Autoclave Test Protocol

| | Initial | Final | Stirrer | |
|---|---|---|---|---|
| Duration | Temperature | Temperature | Speed | |
| (Hours) | (° F.) | (° F.) | (RPM) | Pressure |
| 2 | 110 | 110 | 400 | 4000 |
| 6 | 110 | 40 | 0 | 4000 |
| 24 | 40 | 40 | 0 | 4000 |
| 6 | 40 | 40 | 100 | 4000 |
| 2 | 40 | 40 | 400 | 4000 |
| 2 | 40 | 40 | 50 | 4000 |
| 2 | 40 | 40 | 0 | 4000 |
| 2 | 40 | 40 | 50 | 4000 |

TABLE 5
Autoclave Performance Test Data for Example
AAs and conventional Inhibitor A

| | Dose Rate (Vol/Vol; | |
|---|---|---|
| Chemicals | Based on Brine) | Pass/Fail |
| None (Blank) | 0 | Fail |
| Inhibitor A | 1.0 | Fail |
| Inhibitor A | 2.0 | Pass |
| AA Example 1a | 2.0 | Pass |

As with the rocking cell unit test, the results from the autoclave testing indicates that polyester amine salt AA samples, when applied to the fluid in low dosages, were effective in inhibiting the agglomeration of hydrates.

In the foregoing specification, the invention has been described with reference to specific embodiments thereof, and has been described as effective in providing methods, compounds, and treatments for inhibiting hydrate agglomeration in a fluid. However, it will be evident that various modifications and changes can be made thereto without departing from the broader spirit or scope of the invention as set forth in the appended claims. Accordingly, the specification is to be regarded in an illustrative rather than a restrictive sense. For example, fluids, reagents, anhydrides, diacids, tertiary amines, organic acids, solvents, reaction conditions and devices, mixtures, and the amounts of inhibitor falling within the claimed parameters, but not specifically identified in this disclosure or evaluated in a particular Example, are expected to be within the scope of this invention.

The present invention may suitably comprise, consist or consist essentially of the elements disclosed and may be practiced in the absence of an element not disclosed. For instance, the methods may comprise, consist essentially of, or consist of the steps or components recited in the independent claims, respectively.

In one non-limiting embodiment, there is provided a method for synthesizing a polymeric anti-agglomerant hydrate inhibitor, where the method consists essentially of or consists of forming a polyester amine precursor through a condensation reaction between a cyclic anhydride and a tertiary amine in the presence of a condensation catalyst, and reacting the polyester amine precursor with a carboxylic acid to create a polyester amine salt.

In one non-restrictive version, there is provided a method for inhibiting hydrate formation in a two-phase fluid, where the method consists essentially of or consists of introducing an effective amount of a polyester amine salt anti-agglomerant hydrate inhibitor to the two-phase fluid comprising, consisting essentially of, or consisting of an aqueous phase and a hydrocarbon phase to prevent the agglomeration of hydrates.

The words “comprising” and “comprises” as used throughout the claims, are to be interpreted to mean “including but not limited to” and “includes but not limited to”, respectively.

As used herein, the singular forms “a,” “an,” and “the” are intended to include the plural forms as well, unless the context clearly indicates otherwise.

As used herein, the term “about” in reference to a given parameter is inclusive of the stated value and has the meaning dictated by the context (e.g., it includes the degree of error associated with measurement of the given parameter).

As used herein, the term “and/or” includes any and all combinations of one or more of the associated listed items

1. A method for synthesizing a polymeric anti-agglomerant hydrate inhibitor, the method comprising:
forming a polyester amine precursor through a condensation reaction between a cyclic anhydride and a tertiary amine-diol in the presence of a condensation catalyst; and
reacting the polyester amine precursor with a carboxylic acid to create a polyester amine salt.

2. The method of claim 1, wherein the cyclic anhydride is selected from the group consisting of maleic anhydride, succinic anhydride, alkyl-substituted anhydrides, alkenyl-substituted anhydrides, and mixtures thereof; where the alkyl and alkenyl substituents have from 1 to 20 carbon atoms and are linear or branched.

3. The method of claim 2, wherein the cyclic anhydride is dodecenyl succinic anhydride.

4. The method of claim 1, wherein the tertiary amine-diol is an alkyldiethanolamine, wherein the alkyl group contains 1 to 10 carbon atoms and is linear, branched, or cyclic.

5. The method of claim 4, wherein the tertiary amine-diol is n-butyldiethanolamine.

6. The method of claim 1, wherein the condensation catalyst is selected from a group consisting of methanesulfonic acid, p-toluenesulfonic acid, dodecylbenzenesulfonic acid, sulfuric acid, phosphoric acid, phosphorous acid, and combinations thereof.

7. The method of claim 1, wherein the carboxylic acid contains 1 to 20 carbon atoms.

8. The method of claim 7, wherein carboxylic acid is selected from the group consisting of acetic acid, acrylic acid, citric acid, and mixtures thereof.

9. The method of claim 3, wherein the polyester amine polymer precursor is reacted with the carboxylic acid in the presence of a solvent selected from a group consisting of alcohols having 1 to 10 carbon atoms, glycols having at least 2 carbon atoms, glycol ethers, ketones having 3 to 12 carbon atoms, amides having 3 to 12 carbon atoms, esters having 2 to 20 carbon atoms, aromatic hydrocarbons having 6 to 12 carbon atoms, phenols having 6 to 12 carbon atoms, and mixtures thereof.

10. A method of inhibiting hydrate agglomeration in a multi-phase fluid, the method comprising
introducing an effective amount of a polyester amine salt anti-agglomerant hydrate inhibitor to the multi-phase fluid comprising an aqueous phase, a liquid hydrocarbon phase, and/or natural gas to prevent the agglomeration of hydrates.

11. The method of claim 10, wherein the multi-phase fluid is selected from the group consisting of crude oil, production fluid, wet natural gas, drilling fluid, drill-in fluid, completion fluid, and mixtures thereof.

12. The method of claim 10, wherein the polyester amine salt anti-agglomerant hydrate inhibitor is introduced to the liquid hydrocarbon phase of the multi-phase fluid.

13. The method of claim 10, wherein the aqueous phase of the fluid is comprised of water or brine and makes up about 1 vol. % to about 80 vol. % of the multi-phase fluid, based on total volume of liquid in the fluid.

14. The method of claim 10, wherein the polyester amine salt anti-agglomerant hydrate inhibitor is made by a process comprising forming a polyester amine precursor through a condensation reaction between a cyclic anhydride and a tertiary amine-diol in the presence of a condensation catalyst; and reacting the polyester amine polymer precursor with an organic acid.

15. The method of claim 14, wherein cyclic anhydride is selected from a group consisting of octenyl succinic anhydride, dodecenyl succinic anhydride, tetradecenyl succinic anhydride, octadecenyl succinic anhydride, maleic anhydride, succinic anhydride, phthalic anhydride, hexahydrophthalic anhydride, and mixtures thereof.

16. The method of claim 14, wherein the tertiary amine-diol is an alkydiethanolamine wherein the alkyl group contains 1 to 10 carbon atoms and is linear, branched, or cyclic.

17. The method of claim 14, wherein the organic acid is selected from a group consisting of acetic acid, acrylic acid, citric acid, methanesulfonic acid, dodecylbenezenesulfonic acid, an anionic phosphate ester having 1 or 2 alkyl groups, and mixtures thereof.

18. The method of claim 14, wherein the polyester amine polymer precursor is reacted with the organic acid in the presence of a solvent selected from a group consisting of methanol, isopropanol, butanol, polypropylene glycol, diethylene glycol, ethylene glycol monobutyl ether, methyl isobutyl ketone, ethyl acetate, dimethylformamide, toluene, xylene, aromatic naphtha, cresol, and mixtures thereof.

19. The method of claim 10, wherein the effective amount of the polyester amine salt anti-agglomerant hydrate inhibitor ranges from about 0.1 vol. % to about 6.0 vol. %, based on volume of aqueous phase.

20. The method of claim 10, wherein the ratio of cyclic anhydride to tertiary amine-diol ranges from about 2:1 to about 1:2.

21. The method of claim 10, wherein the multi-phase fluid is at a temperature ranging from about −10° C. to about 10° C. and at a pressure above 1000 psi.
